(19) United States
(12) Patent Application Publication
(10) Pub. No.: US 2025/0332718 A1
(43) Pub. Date: Oct. 30, 2025

(54) METHOD FOR HANDLING AN OBJECT BY MEANS OF A ROBOTIC ARM, AND DEVICE COMPRISING A ROBOTIC ARM FOR HANDLING AN OBJECT

(71) Applicant: Robominds GmbH, München (DE)

(72) Inventors: Tobias RIETZLER, München (DE); Andreas DÄUBLER, München (DE); Manfred RIETZLER, Bangkok (TH)

(21) Appl. No.: 18/877,649

(22) PCT Filed: Jun. 13, 2023
(86) PCT No.: PCT/EP2023/065724

§ 371 Date: Jul. 8, 2025

(30) Foreign Application Priority Data
Jun. 23, 2022 (DE) 10 2022 115 662.1

(51) Int. Cl. B25J 9/16

(52) U.S. Cl. CPC B25J 9/1612; B25J 9/163

(57) ABSTRACT

The invention relates to a method for handling an object (20) by means of a robotic arm (10), the method comprising the following steps:
a. detecting at least one object (20) and measuring at least one measurement value of at least one object property of the object (20) by means of at least one sensor (31, 32);
b. determining at least one handling property by querying the measurement value in a database and/or by inference with a statistical model involving entering the measurement value;
c. creating a set of control data for the robotic arm (10) based on the handling property; and
d. handling the object (20) by means of the robotic arm (10) according to the set of control data.

Furthermore, the invention relates to a device for handling objects (20), the device comprising a robotic arm (10), at least one sensor (31, 32), and a computer system (40).

The invention relates to a method for handling an object by means of a robotic arm according to claim 1 and a device comprising a robotic arm for handling an object according to claim 11.

Robots which pick up an object by means of a robotic arm and a correspondingly suitable gripper, move it to a predetermined placement location and place it there (referred to as pick & place robots) are known from the prior art. In this context, it is important that the robot's gripping action and the subsequent movements performed together with the object are adapted to the object in such a manner that the object is not damaged. In particular, a gripping force that is too strong or too weak can damage the object by crushing or dropping it. The manner in which the object must be held in order to avoid damage is highly object-specific. As a result, the object must be identified before the handling parameters are selected. However, the disadvantage of the method known in the prior art is that it is only possible to handle identifiable and previously known objects.

There is therefore a great need for a method and a device for handling an object where the object is not necessarily previously known and/or identified. The handling of the object should be as reliable, safe, smooth and fast as possible, without delay, deceleration or interruption. In addition, the method should be cost-effective to implement and the device should be cost-effective to produce and operate, with a further focus being on making it as compact and space-saving as possible. The object of the invention is to provide such a method and such a device, overcoming the disadvantages of the prior art while taking up the least possible space.

This object is attained in a surprisingly simple but effective manner by a method for handling an object according to the teaching of independent claim 1 and by a device comprising a robotic arm for handling an object according to the teaching of claim 11.

According to the invention, a method for handling an object by means of a robotic arm is proposed, the method comprising the following steps:
a. detecting at least one object and measuring a measurement value of at least one object property of the object by means of at least one sensor;
b. determining at least one handling property by querying the measurement value in a database and/or by inference with a statistical model involving entering the measurement value;
c. creating a set of control data for the robotic arm based on the handling property; and
d. handling the object by means of the robotic arm according to the set of control data.

In the context of the invention, it has been recognized that the handling of unknown objects frequently fails because no handling properties can be assigned to the object if the object is not identified. So the handling of the object fails because it is not known how the unidentified object is to be handled. In the context of the invention, it has been recognized that the exact identification of the object is not necessary for the assignment of handling properties; instead, object properties allow conclusions to be drawn about handling properties. The method makes it possible to draw such conclusions reliably.

In order for handling of the object to be possible at all, the at least one object must first enter the sphere of action of the robotic arm and be detected by it in step a. This means that the object must be provided in a manner allowing the sensor to measure the measurement value and subsequently allowing handling by the robotic arm. In particular, the detection of the object causes the triggering of the measurement by the sensor for determining the measurement value of the object property. The sensor determines the measurement value by measuring. It is conceivable that the measurement value of the sensor simultaneously or successively encompasses multiple identical object properties of multiple objects. For example, the sensor simultaneously or successively records the total weight of multiple objects. Furthermore, it is conceivable that the sensor is part of a measuring device with a data processing device and the measuring device receives the measurement value by calculating it from the data acquired by the sensor in the data processing device. Preferably, at least 2, 3, 4, 5, 6, 7, 8, 9, 10, 11, 12, 13, 14, 15, 16, 17, 18, 19 or 20 objects are detected simultaneously or successively. Further preferably, at least 2, 3, 4, 5, 6, 7, 8, 9, 10, 11, 12, 13, 14, 15, 16, 17, 18, 19 or 20 identical or different measurement values are measured. Even more preferably, at least 2, 3, 4, 5, 6, 7, 8, 9, 10, 11, 12, 13, 14, 15, 16, 17, 18, 19 or 20 sensors record at least one measurement value. The term “object property” refers to a state variable and/or a characteristic assigned to the object, in particular a specific marking that allows conclusions to be drawn about the identity, the type and/or the safe handling of the object. In particular, the term “object property” covers the interaction with other objects and/or with the environment. Furthermore, it includes characteristics that are closely related to the object but not necessarily and/or inevitably inherent to it.

The term “measurement value” refers to the quantization, the manifestation and/or the digitization of an object property.

In step b., the measurement value measured in step a. is queried in a database and/or entered into a statistical model. At least one handling property is uniquely stored in the database for any number of measurement values. If the queried measurement value is stored in the database, the object is identified and the database returns the at least one handling property. Preferably, the type of the object is also stored. In addition or alternatively, the measurement value is entered into a statistical model. The statistical model has been trained before and/or is being trained during the execution of the method using training data sets. The statistical model infers at least one, preferably an optimal and/or correct, handling property from the measurement value. It is conceivable that the statistical model infers the at least one, preferably optimal and/or correct, handling property from the fact that all the recorded and weighted measurement values match the closest with the training measurement values of a particular other object and therefore the at least one handling property stored for this particular other object is the at least one, preferably optimal and/or correct, handling property. Even more preferably, it is conceivable that the statistical model infers the at least one, preferably optimal and/or correct, handling property from the fact that the individual recorded and weighted measurement values match the closest with individual training measurement values and the handling property stored for the individual training measurement values is the at least one optimal and/or correct handling property. In other words, the inference of the statistical model corresponds to the at least one handling property of a particular other object, or the inference is formed based on different handling properties of different objects. The advantage of the first approach is that, in particular, multiple handling properties are guaranteed to match each other. The advantage of the second approach is that, in particular with multiple handling properties, these handling properties match the detected unknown object more individually and therefore potentially more optimally and/or correctly. In other words, for a measurement value not stored in the database, an inference regarding at least one, preferably optimal and/or correct, handling property can still be made using the statistical model, without the object being or having to be identified. It is therefore irrelevant for the success and/or feasibility of the method what the object ultimately is; at least one handling property can still be assigned to the object. Even more preferably, at least 2, 3, 4, 5, 6, 7, 8, 9, 10, 11, 12, 13, 14, 15, 16, 17, 18, 19 or 20 identical or different handling properties are determined in in step b. In this context, it is particularly preferred if at least one first sensor measures at least one first measurement value and at least one second sensor measures at least one second measurement value in step a., at least one first handling property being determined by querying the first measurement value in a database and at least one second handling property being determined by inference with a statistical model involving entering the second measurement value in step b. In this manner, the advantages of both approaches can be exploited particularly well. In particular, it has been recognized that handling properties based solely on the design of the object are better queried in a database, whereas handling properties resulting from the interaction of the object with the environment are better determined using a statistical model. The manner in which the database is formed is arbitrary. It can be a database created specifically for the procedure. However, it is also conceivable that the database is generally accessible and/or intended for other methods. In this case, the database serves for the general networking and digital accessibility of objects, and the method makes use of the stored information.

The term “optimal and/or correct handling property” refers to a handling property that a knowledgeable and experienced person skilled in the art who is familiar with the detected object would consider optimal and/or correct in the given environment in which the method is carried out. Furthermore, it is obvious to a person skilled in the art that the measurement value depends on the type of sensor used and, depending on the type of sensor used, a measurement value of one variation can be a handling property of another variation of the method according to the invention. For example, in one variation, the sensor is part of a lidar and the measurement value is thus the position of the object, which is simultaneously the object property of the pickup place, while in another variation, the sensor is a camera and the measurement value is therefore an image from which the object property of the pickup place is inferred by means of the statistical model.

In step c., a set of control data for the robotic arm is created based on the handling property. It is also conceivable that in addition to the stored handling properties, further information outside the object is taken into account. The information may preferably concern the robotic arm, in particular a state of the robotic arm, the environment in which the method is being carried out, in particular a state of the environment, and/or the user, in particular specifications given by the user implementing the method. The set of control data specifies to the robotic arm motion sequences which the robotic arm is to carry out.

In step d., the robotic arm handles the object according to the set of control data. That is, the robotic arm performs the movements specified by the set of control data.

The method according to the invention makes it possible to automatically handle an identified or unidentified object by a robotic arm in a simple, fast and easily adaptable manner. Hence, pertinent operations of the robotic arm are not prevented, delayed or interrupted if an object that cannot be identified under the given circumstances emerges. The handling of the identified or the unidentifiable object by the robotic arm is smooth, reliable, safe and fast.

Advantageous embodiments of the invention, which can be realized individually or in combination, are set forth in the dependent claims.

In an advantageous variation of the method, in step a., the measured object property is a property inherent to the object, a property influenced by the environment and/or a property assigned to the object. A property inherent to the object is, in particular, but by no means exclusively, the volume, the contours, the dimensions, the filling level, the content, the weight, the aggregate state, the hardness, the strength, the density, the roughness, the composition, the refractive index, the temperature and/or the color. A property influenced by the environment is, in particular, but not exclusively, the position, the orientation, the obstruction, in particular the obstruction by at least one other object, the temperature and/or the type of delivery, in particular the packaging, a note on the packaging, the sender, attached information and/or the type of container containing the object. A property assigned to the object is in particular, but by no means exclusively, an identification number, an identification name, a product number, a product name, an article number or an article name. It is conceivable that the property assigned to the object may be assigned arbitrarily, randomly or systematically. In principle, the object property can be anything, as long as the measurement value representing it allows an inference to at least one handling property and/or a retrieval of at least one handling property in a database, preferably identifying the object. The object properties listed above enable the acquisition of a measurement value representing them that is particularly suitable for being matched with a database and/or for allowing inferences to be made about an optimal and/or correct handling property. The properties assigned to the object, in particular, are particularly suitable for matching with a database. Object properties inherent to the object are particularly suitable for matching the measurement value with a statistical model.

Advantageously, it is also conceivable that the handling property in step b. is a grip strength, a point of attack, a pickup place, a pickup orientation, an obstruction, a placement orientation, a transport orientation, a placement location, a maximum acceleration, a maximum speed and/or the minimum lifting height. In principle, the handling property can be chosen at will, as long as it satisfies the claims of the invention for the most reliable, safe and fast handling possible. In particular, the handling property should prevent damage and/or deterioration of the object during rapid handling.

Moreover, it is advantageously conceivable that in step b. the inference is carried out by means of the statistical model if the query of the measurement value in the database fails. In the context of the invention, it has been recognized that handling by a set of control data, which has been created on the basis of at least one handling property that is uniquely assigned to the detected object, is, at least for certain handling properties known to the person skilled in the art, more reliable, better and safer. Therefore, it is preferable to favor a unique assignment of the detected object with at least one assigned handling property over an inference based on probabilities. Therefore, it is advantageous to first query the measurement value in the database in order to obtain at least one handling property assigned to the object and, only if this fails, to make an inference using the statistical model to obtain at least one statistically suitable handling property.

In a preferred alternative, it is conceivable that in step b. at least one other measurement value is detected by means of at least one other sensor and the inference is carried out by means of the statistical model by entering the other measurement value if the query of the measurement value in the database fails. In other words, in step a. at least one first measurement value of at least one first object property is detected by means of at least one first sensor, and in step b. an attempt is made to determine at least one handling property by querying the first measurement value in the database. If the first measurement value is not available and/or retrievable in the database, the query fails and a step a2 is then carried out, which comprises the measurement of at least one second measurement value of at least one second object property of the object using at least one second sensor. Subsequently, in a step b2, at least one handling property is determined by means of inference with a statistical model by entering the second measurement value. This makes it possible, on the one hand, to exploit the advantage offered by handling properties that are specifically stored for an object and, at the same time, to have a procedure for objects whose first measurement value cannot be found in the database. In particular, it has been recognized that, as described elsewhere, some object properties, in particular those randomly, arbitrarily and/or systematically assigned to the object, are particularly well suited for querying a database, but have little or no direct connection to a handling property, so that no statistically sound conclusion can be drawn on their basis regarding a correct and/or optimal handling property. Therefore, it is advantageous to measure at least one second measurement value, which has a statistically relevant relationship to at least one handling property and is therefore suitable as a basis for a statistically sound inference using a statistical model.

Furthermore, it is advantageously conceivable that in step b. the database and/or the statistical model is/are extended and/or updated by the measurement value measured in step a. and/or the other measurement value measured in step b. Within the scope of the invention, it has been recognized that the physical expression and thus the measurement value of an object property of an object can change temporarily or permanently. The cause of this is arbitrary; possible conceivable causes are, for example, a new design of the object or a new article number assigned to the object. It has also been recognized that optimal and/or correct handling properties can be inferred by means of the statistical model in particular if the statistical model is trained with a large amount of typical and/or true-to-life data (training data). The measurement values of objects, which occur during operation, represent such true-to-life data, which is particularly suitable for training the statistical model. By extending and/or updating the database and/or the statistical model, the method is continuously improved and kept up to date during the running process.

It is also conceivable that the handling includes grasping, picking up, lifting, transporting, sorting, feeding and/or shaking. Basically, it does not matter what the handling of the object ultimately is, as long as the handling is the optimal and/or correct handling property according to the invention. The handling steps mentioned above are common handling steps by which a robotic arm handles an object. The term “feed” refers to the provision of an object to a machine that further processes and/or handles the object in a form suitable for the machine.

It is also advantageous if step d. further includes evaluating the handling and obtaining an evaluation, as well as optionally displaying the evaluation. This evaluation makes it possible to assess the quality of the handling. Advantageously, is also possible to extend and/or update the handling properties in the database and/or the statistical model using the evaluation in order to obtain the advantages described elsewhere. In this manner, the handling can be continuously optimized during operation. In particular, the statistical model can be continuously trained, improved and/or adapted by the evaluation, so that for new objects that cannot be queried in the database, the optimal and/or correct handling property can be inferred with a higher probability by means of the statistical model when the method according to the invention is repeated. It is also conceivable that the handling property in the database is updated and/or extended, thus enabling damage-free and/or error-free handling of future objects with the same measurement value as the evaluated object. It is conceivable that the evaluation is carried out by means of the existing sensors or by means of sensors specially installed for the evaluation.

In a further embodiment, it is conceivable that the control data set in step d. is updated and/or extended taking into account the evaluation. In this manner, it is possible to recognize a possibly faulty handling and/or a handling endangering the object during the handling of the object and to prevent a deterioration and/or damage to the object during the handling by adapting the set of control data.

In a particularly preferred embodiment of the invention, it is conceivable that the object is a medical sample or a container holding a medical sample, the handling property in step b. is a placement location, the placement location being the position of a feeding device of a medical analytical instrument, and the handling in step b. comprises the feeding of the object to the feeding device. In principle, it is arbitrary which type of object and which type of handling are carried out with the method according to the invention. However, it has been recognized in the context of the invention that the method is particularly suitable for handling medical samples or containers of medical samples. This is due to the fact that, although medical samples are a limited number of types of objects that differ fundamentally in their object properties, they may not have a complete and directly assignable range of measurement values of object properties, so that a complete and fully comprehensive database can only be created with a great deal of effort. Furthermore, it has been recognized that different types of medical samples are to be fed to different analytical instruments. On the basis of the object properties, it is possible to determine which type of medical sample is present or which type of medical analytical instrument the medical sample is to be fed to. The method according to the invention therefore enables the fast, easy and safe handling of medical samples. It is also conceivable that the pickup location of the object is a delivery zone for objects to be handled for the first time or is the execution unit of the medical analytical instrument for objects that have already been handled once or multiple times.

It is assumed that the definitions and explanations of the above terms apply to all aspects described in this description below, unless otherwise stated.

In accordance with the invention, a device for handling objects is also proposed, the device comprising a robotic arm, at least one sensor and a computer system, wherein the computer system comprises a computer-readable storage medium comprising a database and/or a statistical model for carrying out step b. of a method described elsewhere and carried out by the device, and a data processing device for carrying out steps b. and c. of the method described elsewhere. The advantageous method, together with the advantages described therein, can be carried out by means of the device according to the invention. The device preferably comprises at least 2, 3, 4, 5, 6, 7, 8, 9, 10, 11, 12, 13, 14, 15, 16, 17, 18, 19 or 20 identical or different sensors.

It is also conceivable that the sensor is a light sensor, a force-torque sensor or a pressure sensor or is part of a device, in particular a bar code scanner, an RFID scanner, an image capturing device, a lidar, a radar, a tactile sensor system or a measuring device, in particular a spectrometer, an ultrasonic measuring device, an X-ray device, a refractometer, a thermometer, a moisture meter and/or a scale. In principle, any type of sensor can be used to measure the measurement value, as long as it meets the requirements of the invention and can detect a suitable measurement value of an object property that is suitable according to the invention. Which object property is suitable according to the invention depends to a large extent on the objects to be expected and thus on the intended purpose of the device. The sensors and/or devices mentioned above are particularly suitable for one or more specific purposes. The corresponding purposes and the sensors and/or devices suitable for them are apparent to a person skilled in the art.

In a further development of the invention, it is conceivable that the robotic arm has one axis or multiple axes. A single-axis robot has the advantage that it is easier to control and monitor. A multi-axis robot, on the other hand, can reach a larger area of accessible surfaces, which, for example, serve as placement locations, and/or can influence the placement orientation of the object. Particularly preferably, the robotic arm is guided on a rail. Furthermore, it is conceivable that the robotic arm comprises a gripping device with at least one finger and/or at least one suction cup. The gripping device facilitates the secure gripping and transportation of the object.

It is also conceivable that the computer system includes an interface and/or a network connection. The network can be an intranet consisting of at least one other computer system and/or the internet. The interface and/or the network connection make it possible to provide the computer system with additional user information, described elsewhere, to be taken into account when creating the control instructions. Likewise, entries and/or updates in the database, in particular handling properties for certain objects, can be made by means of the interface and/or the network connection. Furthermore, it is conceivable that the database is partially or completely located outside the computer system and that the computer system is connected to the database by means of the network connection. The manner in which the entries and/or updates for the database are generated is basically arbitrary. It is preferably conceivable that the entries and/or updates are made by the measurement values recorded by the computer system, as described elsewhere. Even more preferably, it is conceivable that the database can be updated and/or extended by at least one other identical or different computer system that is also capable of recording measurement data and/or by storing data of the object during production and/or a detecting of the object. In particular, it may be the database described elsewhere that serves for general networking and digital accessibility. Furthermore, it is possible to provide training data sets for training the statistical model by means of the interface and/or the internet connection. This enables safe, correct and/or optimal handling of individual objects in advance.

In a further development of the invention, it is conceivable that the objects to be handled are medical samples and/or containers each holding a medical sample and the device comprises at least one medical analytical instrument. As described elsewhere, the method according to the invention is particularly suitable for handling medical samples and containers holding medical samples. Therefore, the device is also particularly suitable for handling medical samples or containers holding medical samples. In order to fully exploit the advantages of the device according to the invention, it is advantageous if the device comprises at least one medical analytical instrument, preferably at least 2, 3, 4, 5, 6, 7, 8, 9, 10, 11, 12, 13, 14, 15, 16, 17, 18, 19 or 20 identical or different medical analytical instruments, to which the medical sample or the container holding the medical sample can be fed to during handling.

In a further development, it is conceivable that the medical analytical instrument is a polymerase chain reaction (PCR) test device, a real-time PCR test device, a sequence analyzer, a blood analyzing device, in particular a blood glucose meter or a lactate meter, a coagulometer, a blood alcohol meter, a refractometer, a pH meter, a urinanalysis device and/or a photomicroscope. In principle, the type of medical analytical instrument is optional. The analytical instruments mentioned above are analytical instruments that are widely used in the medical field. The skilled person is aware of the respective advantages and fields of application of the analytical instruments.

Further details, features and advantages of the invention will become apparent from the following description of the preferred embodiment in conjunction with the sub-claims. In this respect, the respective features can be realized individually or in combination with each other. The invention is not limited to the embodiment. The embodiment is shown schematically in the figures.

In detail

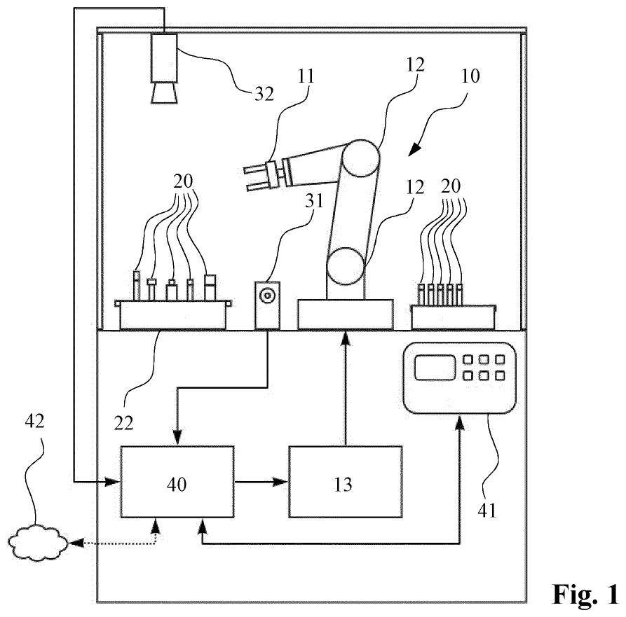

FIG. 1 shows a schematic side view of a device according to the invention; and

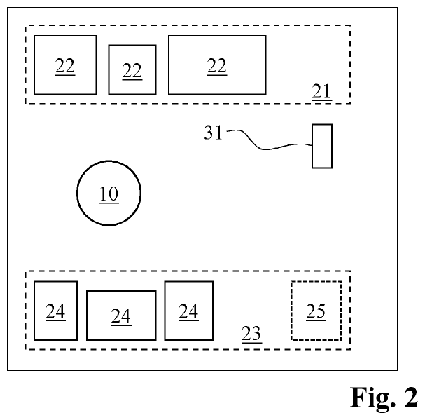

FIG. 2 shows a schematic top view of the device according to the invention.

FIG. 1 shows a schematic side view of a device according to the invention. The device is used in a medical laboratory for analyzing medical samples. The device includes a robotic arm 10. In FIG. 1, the robotic arm is biaxial, i.e. it has two axes 12. Furthermore, the robotic arm includes a gripping device 11, with which it can grasp objects 20. On the left of the picture, multiple differently designed objects 20, which are different medical samples in containers, are ready for handling in a packaging 22. A first sensor 31 is available for their identification. In the present case, the first sensor 31 is part of an RFID scanner. The objects 20 have a corresponding RFID chip with an identification number that characterizes the object 20. The first sensor 31 measures a first measurement value in the form of the identification number from the chip. Furthermore, the first sensor 31 is connected to a computer system 40. If the first sensor 31 measures the identification number of an RFID chip, it reports the measured identification number to the computer system 40. The computer system 40 compares the identification number with a database. The database contains corresponding first handling instructions for the identification number, namely grip strength, point of attack, placement location, placement orientation, maximum speed and maximum acceleration for creating sets of control data for the robotic arm 10. The device also includes a second sensor 32, which is a camera. The second sensor 32 detects the objects 20 and transmits a second measurement value in the form of an image to the computer system 40. Using a statistical model, second handling properties, namely an obstruction, a pickup location and a pickup orientation of the individual objects 20, are inferred. Furthermore, the position of the robotic arm 10 is additionally provided to the computer system 40 as additional information. If the RFID chip is lost before the provision, it is possible to determine the first handling instructions from the second measurement value, also by means of the statistical model, after the query of the measurement value in the database fails from a logical point of view. From the handling properties and the additional information, a data processing device comprised by the computer system 40 compiles a set of control data for controlling the robotic arm 10 and transmits it to a control system 13 of the robotic arm 10. The computer system 40 has an interface 41 into which a user can also enter additional information concerning the handling properties. When the set of control data is created, this information is taken into account by the computer system 40. Furthermore, the computer system 40 includes an internet connection 42. The internet connection 42 makes it possible to provide training data sets for the statistical model or to also transmit additional information to the computer system regarding the handling. The additional information can be taken into account by the computer system 40 when creating the set of control data or can be stored in the database as handling property for later consideration. The additional information provided via the internet connection 42 and stored in the database for the identification number includes, in particular, the placement location, which is a feeding device for an analytical instrument not shown in FIG. 1. For this purpose, a user indicates the identification number and the type of sample, which provides information about the desired examination, for example “blood”, or directly indicates the desired analytical instrument, and then the RFID-chipped container holding the medical sample of the device according to the invention is provided and handled according to the previously described method.

The statistical model can also be trained during operation. For this purpose, the second sensor 32 continuously takes an image while the robotic arm 10 is handling the object 20. The handling is then evaluated via the image, and an evaluation is obtained. The statistical model is further trained by means of the evaluation.

FIG. 2 shows a top view of the device according to the invention. The robotic arm 10 is arranged between a provision area 21 with various packagings 22 and a placement area 23. The packaging 22 contains objects not shown in FIG. 2, which are detected by means of the first sensor 31. In the placement area 23 there are three feeding devices 24 for various medical analytical instruments, which are not shown in FIG. 2. These feeding devices are carriers for medical sample containers. The robotic arm 10 handles the various objects according to the set of control data by removing them from the packaging 22 and feeding them to the designated feeding devices 24. Furthermore, the storage area 23 has a sorting device 25 into which the robotic arm 10 sorts damaged sample containers according to the set of control data.

1. A method for handling an object (20) by means of a robotic arm (10), the method comprising the following steps:
a. detecting at least one object (20) and measuring at least one measurement value of at least one object property of the object (20) by means of at least one sensor (31, 32);
b. determining at least one handling property by querying the measurement value in a database or by inference with a statistical model involving entering the measurement value;
c. creating a set of control data for the robotic arm (10) based on the handling property; and
d. handling the object (20) by means of the robotic arm (10) according to the set of control data.

2. The method according to claim 1, wherein the object property in step a. is a property inherent to the object (20), a property influenced by the environment or a property assigned to the object (20), or both a property inherent to the object (20), a property influenced by the environment and a property assigned to the object (20).

3. The method according to claim 1, wherein the handling property in step b. is a grip strength, a point of attack, a pickup place, a pickup orientation, an obstruction, a placement orientation, a transport orientation, a placement location, a maximum acceleration, a maximum speed a minimum lifting height or any combination thereof.

4. The method according to claim 1, wherein, in step b., the inference by means of the statistical model takes place if querying the measurement value in the database fails.

5. The method according to of claim 1, wherein, in step b., at least one other measurement value is detected by means of at least one other sensor (32) and the inference by means of the statistical model involving entering the other measurement value takes place if querying the measurement value in the database fails.

6. The method according to claim 1, wherein, in step b., the database or the statistical model is extended or updated with the measurement value measured in step a. or the other measurement value measured in step b., or the database or the statistical model is extended or updated with the measurement value measured in step a. and the other measurement value measured in step b.

7. The method claim 1, wherein the handling comprises gripping, picking up, lifting, transporting, sorting, feeding shaking, or any combination thereof.

8. The method according to any one of the preceding claim 1, wherein step d. further comprises: evaluating the handling and receiving an evaluation.

9. The method according to claim 8, wherein step d. further comprises: updating or extending the set of control data based on the evaluation, or both updating and extending the set of control data based on the evaluation.

10. The method according to claim 1, wherein the object (20) is a medical sample or a container holding a medical sample, the handling property in step b. is a placement location, the placement location being the position of a feeding device (24) feeding the object to at least one medical analytical instrument, and the handling in step d. comprises feeding the object to the feeding device (24).

11. A device for handling objects (20), the device comprising a robotic arm (10), at least one sensor (31, 32), and a computer system (40), wherein the device uses the method according to claim 1, the computer system (40) comprises a computer-readable storage medium, which comprises the database or the statistical model for executing step b., and a data processing device for executing steps b. and c.

12. The device according to claim 11, wherein the sensor (31, 32) is a light sensor, a torque sensor, a pressure sensor, a barcode scanner, an RFID scanner, an image capturing device, a lidar, a radar, a tactile sensor system, a measuring device, a spectrometer, an ultrasonic measuring device, an X-ray device, a refractometer, a thermometer, a moisture meter, a scale or any combination thereof.

13. The device according to claim 11, wherein the robotic arm (10) has one axis or multiple axes.

14. The device according to claim 11, wherein the computer system (40) comprises an interface (41) or a network connection (42), or wherein the computer system (40) comprises an interface (41) and a network connection (42).

15. The device according to claim 11, wherein the objects (20) to be handled are medical samples or containers each holding a medical sample, and the device comprises at least one medical analytical instrument.

16. The device according to claim 15, wherein the medical analytical instrument is a polymer-chain-reaction (PCR) test device, a real-time-PCR test device, a sequence analyzing device, a blood analyzing device, a blood glucose meter, a lactate meter, a coagulometer, a blood alcohol meter, a refractometer, a pH meter, a urinalysis device, a photomicroscope, or any combination of the foregoing.
